(19) United States
(12) Patent Application Publication
(10) Pub. No.: US 2001/0048992 A1
(43) Pub. Date: Dec. 6, 2001

(54) PHASE TRANSITION TYPE RECORDING MEDIUM STRUCTURE AND METHOD OF FABRICATING THE SAME

(76) Inventors: TZUAN-REN JENG, HSINCHU (TW); PO-FU YEN, TAIPEI (TW); CHI-JUI HO, HSINCHU HSIEN (TW); DON-YAU CHIANG, HSINCHU HSIEN (TW); LONG-YUH HONG, NAN-TOU (TW); DER-RAY HUANG, HSINCHU (TW); TSAI-CHU HSIAO, CHUNG-LI CITY (TW); LII-CHYUAN TSAI, HSINCHU HSIEN (TW)

Correspondence Address: J C PATENTS INC, 4 Venture, Suite 250, IRVINE, CA, 92618, US

(21) Appl. No.: 09/227,387

(22) Filed: Jan. 8, 1999

(30) Foreign Application Priority Data
Aug. 18, 1998 (TW) 87113546

(51) Int. Cl. B32B 3/02

(52) U.S. Cl. 428/64.4

(57) ABSTRACT

A phase transition type recording medium. On a substrate, a lower dielectric layer is formed. An adding dielectric layer having a high reflectivity is formed on the lower dielectric layer. A recording layer is formed on the adding high reflective dielectric layer. An upper dielectric layer is formed on the recording layer. A reflective layer is formed on the upper dielectric layer, and a protecting layer is further formed on the reflective layer.

### CROSS-REFERENCE TO RELATED APPLICATION

This application claims priority benefit of Taiwan application Serial no. 87113546, filed Aug. 18, 1998, the full disclosure of which is incorporated herein by reference.

### BACKGROUND OF THE INVENTION

1. Field of the Invention

The invention relates in general to a recording medium, and more particularly, to optical recording medium structure and the method of fabricating the same.

2. Description of the Related Art

As the computer technique is booming quickly, the medium information which applying computer technique becomes a main stream of the market in the medium information. The optical recording medium such as the read only compact disc (CD-ROM), CD-DA, or recordable CD (CD-R) which can only record data once cannot meet the requirements any more. Since the phase transition type compact disc can record data repeatedly, it comes very popular in the market. In addition, the phase transition type CD also meets the requirements of high density, portable, low recording cost, and stability. The phase transition type CD adapts a way of directly overwriting data, so that the design is straightforward. The theory and method of accessing data from the phase transition type CD are similar to those of a compact disc. By incorporating the technique of laser diode, the phase transition type CD becomes a most popular and desired multi-medium in the market.

The phase transition type CD adapts the theory of storing data according to the different reflectivity between the amorphous and crystalline states of the material used as a recording layer (denote as 12 in FIG. 1). By transition between the amorphous and the crystalline states of parts of the recording layer, the objective of iterative recording is achieved. The recording layer typically comprises chalcogenide alloy. To achieve recording efficiently, the transition time between the amorphous state and the crystalline state of the material is preferred to be less than 100 ns.

In FIG. 1, a cross section view showing a conventional phase transition type CD is shown. A lower dielectric layer 11 is formed on a substrate 10 to control the reflectivity and the thermal conductivity of a laser light, so that the sensitivity of recording is protected and enhanced. A recording layer 12 is coated on the lower dielectric layer 11 for data recording. An upper dielectric layer 13 is formed on the recording layer 12 to protect and to control the intensity of the recorded data. A reflective layer 14 is formed on the upper dielectric layer 13. In the early research stage, zinc sulfide (ZnS) is used as the material for the dielectric layers. However, since the zinc sulfide thin film normally contains large particles, and its thermal conductivity is normally high, therefore, the dielectric layers are easily deteriorated to degrade the sensitivity. Thus, in the conventional structure, about 20 to 30 mol % of silicon dioxide is added into the dielectric layer to reduce the thermal conductivity, and to prevent from deterioration and degrade of sensitivity.

However, the dielectric layers formed by the above methods are normally thick. For example, as disclosed in “Proc. Soc. Photo-Opt. Inst. Eng., v.27, p.1078, 1989” by T. Ohta et al and “J. Appl. Phys. V.82, No. 9, p.4183, 1997” by C. Peng et al, the lower dielectric layer has a thickness larger than 100 nm. A dielectric layer having a thickness larger than 100 nm can only be produced by radio frequency (RF) coating. The time consumed for coating is long, so that the throughput of the products is seriously affected.

### SUMMARY OF THE INVENTION

The invention provides a phase transition type optical recording medium and a method of fabricating the same. An adding dielectric thin film with the high reflectivity higher that that of a lower dielectric layer is formed between the lower dielectric layer and the recording layer. Therefore, the thickness of the lower dielectric layer is decreased to shorten the fabricating time and enhance the throughput.

In addition, while decreasing the thickness of the lower dielectric layer, the write/erase property of the disc is not changed at all.

To achieve the above-mentioned objects and advantages, a phase transition type recording structure is provided. The phase transition type recording medium structure comprises a substrate, a lower dielectric layer on the substrate, an adding dielectric film with a high reflectivity on the lower dielectric layer, a recording layer on the thin film, a upper dielectric layer on the recording layer, a reflective layer on the upper dielectric layer, and a protecting layer on the reflective layer.

A method of fabricating the phase transition type recording medium structure is also provided. On a substrate, a lower dielectric layer is formed. A thin dielectric film having a high reflectivity is formed on the lower dielectric layer. A recording layer is formed on the thin film. An upper dielectric layer is formed on the recording layer. A reflective layer is formed on the upper dielectric layer, and a protecting layer is further formed on the reflective layer.

Both the foregoing general description and the following detailed description are exemplary and explanatory only and are not restrictive of the invention, as claimed.

### BRIEF DESCRIPTION OF THE DRAWINGS

FIG. 1 shows a conventional phase transition type optical recording medium;

FIG. 2 is a schematic cross section view showing a phase transition type optical recording medium in a preferred embodiment according to the invention;

FIG. 3 shows a simulated distribution of the ratio (Rc−Ra)/(Rc+Ra), wherein Rc is the reflectivity of the crystalline state and Ra is the reflectivity of the amorphous state (Ra) of the whole optical recording medium;

FIG. 4 shows a temperature distribution in a vertical direction of the whole phase transition type optical recording medium at points A to E shown in FIG. 3; and

FIG. 5 shows a comparison of the properties of the optical recording media in the convention and the invention.

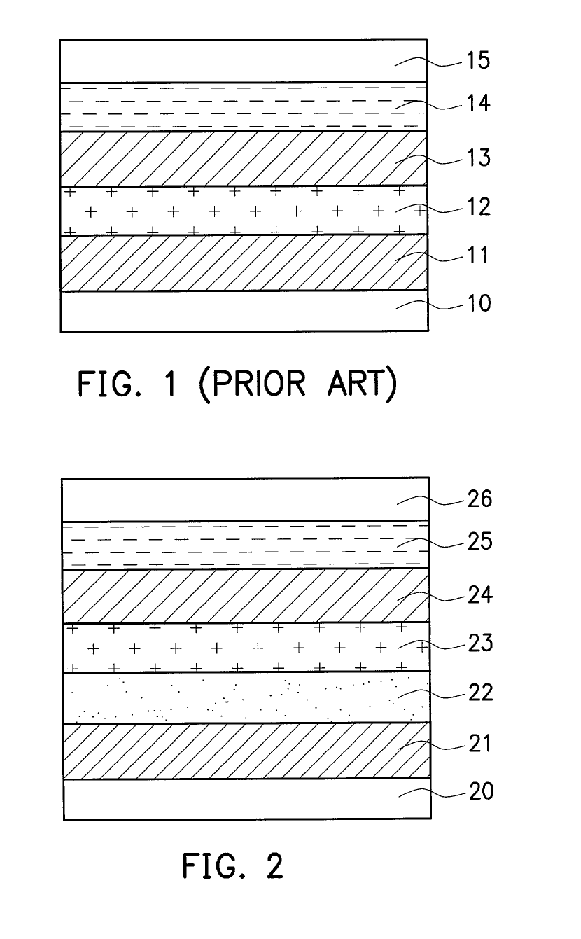

### DESCRIPTION OF THE PREFERRED EMBODIMENTS

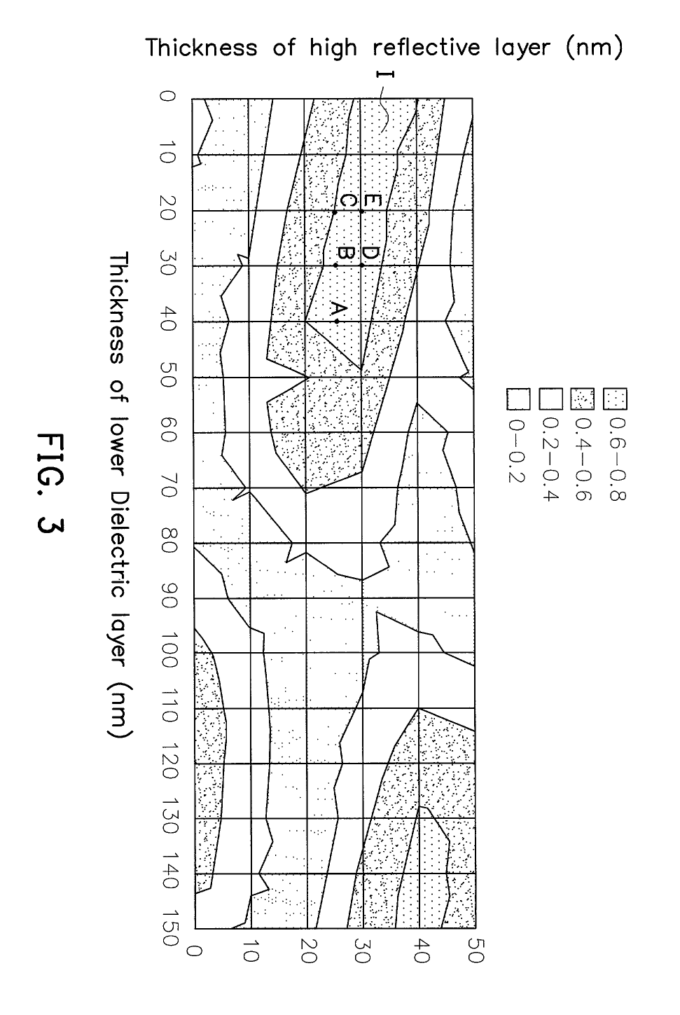

In FIG. 2, a lower dielectric layer 21 is formed on a substrate 20. The material of the substrate 20 includes polycarbonate (PC), whereas the material of the lower dielectric layer 21 includes zinc sulfide added with silicon dioxide. It is appreciated that people skilled in the art may employ materials other than the materials mentioned in the embodiment to achieve the similar effect. Preferably, the lower dielectric layer 21 has a thickness of about 40 nm. An adding dielectric film 22 with high reflective layer is formed, preferably, with a thickness of about 15 nm to 60 nm, preferably, 30 nm, on the lower dielectric layer 21. The material of the high reflective layer 22 may be selected from elements and compound of the fourth (IVA) group in periodic table such as silicon (Si), germanium (Ge), or nitride, oxide, sulfide, carbide, or a mixture or compound of these chemicals. A recording layer 23, a upper dielectric layer 24, a reflective layer 25, and a protecting layer 26 are then formed on the high reflective layer 22 sequentially. The thickness of the recording layer 23 is about 20 to 30 nm, where the thickness of the upper dielectric layer 24 is about 20 to 70 nm, and the thickness of the reflective layer 25 is about 20 to 70 nm.

Referring to FIG. 2 to FIG. 5, a method of fabricating the phase transition type optical recording medium and reducing the thickness of the lower dielectric layer are introduced.

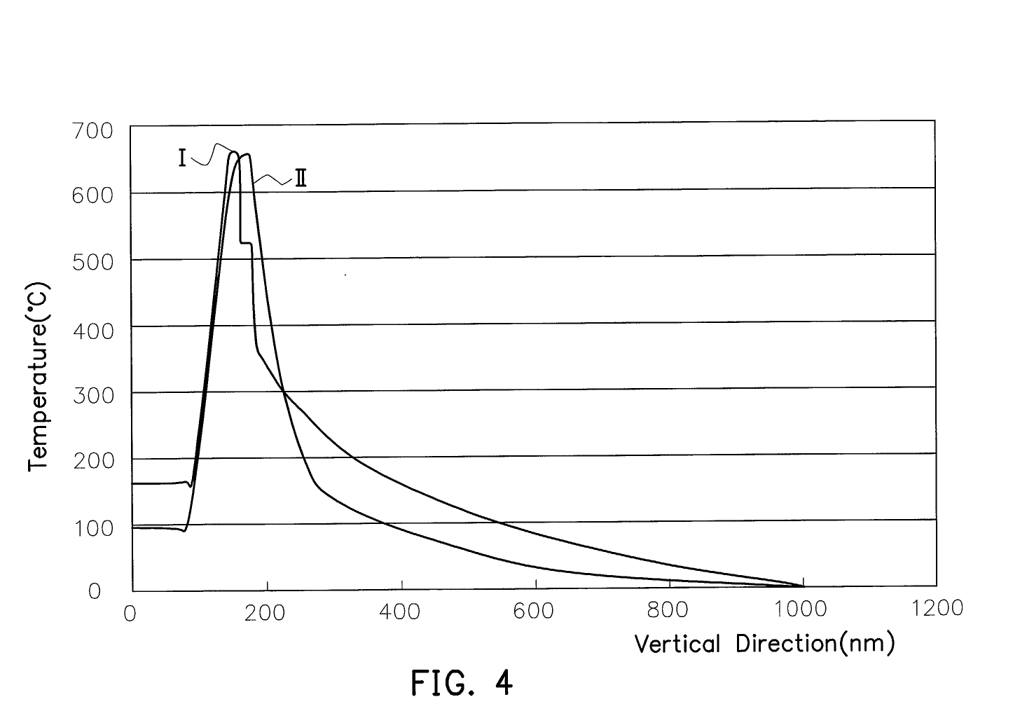

In FIG. 3, the horizontal axis represents the thickness of the lower dielectric layer 21 and the thickness of the high reflective layer 22. Since the refractive index of the high reflective dielectric layer 22 is higher than that of the lower dielectric layer 21, the value of (Rc−Ra)/(Rc+Ra) can be larger than 0.6. Points A, B, C, D, and E in region I represent some better values. It can also be observed from the drawing that the thickness of the high reflective layer is less than about 30 nm, where the thickness of the lower dielectric layer is reduced to a range of about 20 nm to 80 nm. The thickness of the lower dielectric layer is thus reduced greatly.

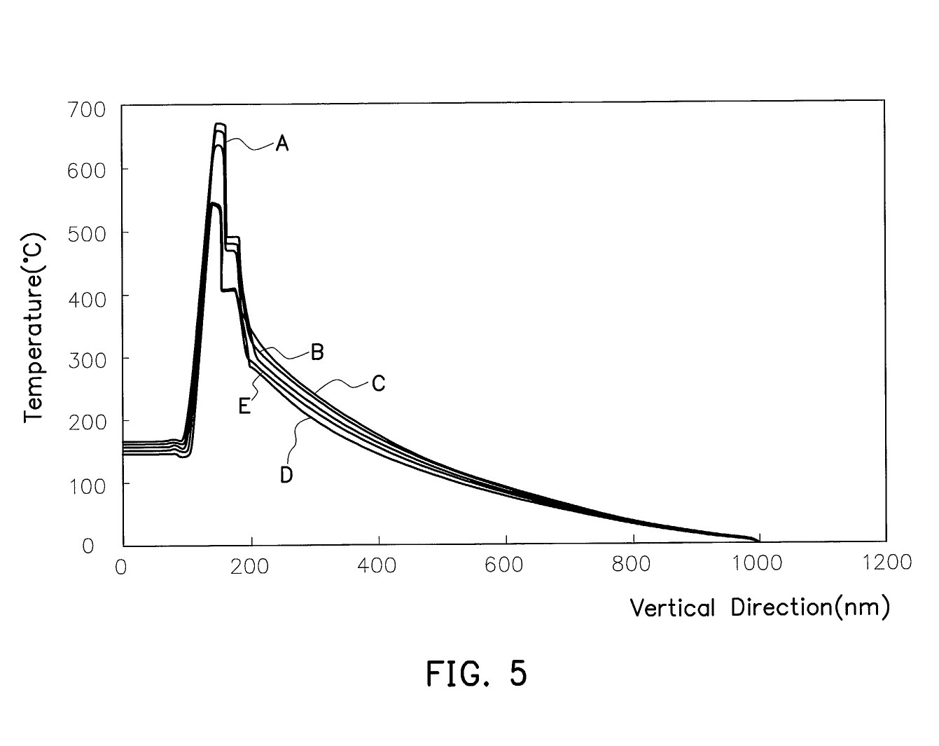

In FIG. 4, a thermal simulation graph showing a temperature distribution corresponding to points A to E in a vertical direction of the phase transition optical disk plant is shown. The original point in the vertical direction represents the surface of the reflective layer. In thermal property, the temperature of the recording medium has to meet the requirement of being erasable. Thus, with a low laser power, a temperature is required to enable the recording medium be crystallized, while with a high laser power, the temperature of the recording medium has to reach a melting point and quenches to an amorphous state to achieve a write state. Thus, in FIG. 4, the curve A meets the requirement most. From the optical simulation of FIG. 3 and the thermal simulation of FIG. 4, the optimum thickness of the high reflective layer 22 is about 25 nm, and the optimum thickness of the lower dielectric layer 21 is about 40 nm. The required thickness of the lower dielectric layer 21 is effectively reduced, so that the coating time is greatly shortened.

In FIG. 2, a lower dielectric layer 21 having a thickness of about 40 nm is formed on a substrate 20. The material of the lower dielectric layer 21 may be selected from zinc sulfide added with silicon dioxide. A high reflective layer 22 having a reflectivity much higher than the lower dielectric layer 21 is formed on the lower dielectric layer 21. Preferably, the high reflective layer is formed from the material of the fourth group element such as silicon and germanium with a thickness of about 25 nm. In addition to the fourth group element, material like nitride, oxide, sulfide, carbide, or a mixture of these material can also be used to form the adding high reflective dielectric layer 22.

A recording layer 23, an upper dielectric layer 24 and a reflective layer 25 are formed on the adding high reflective dielectric layer 22. Preferably, the thickness of the recording layer 23 is about 20 to 30 nm, while the upper dielectric layer 24 has a thickness of about 20 to 70 nm, and the upper dielectric layer 25 has a thickness of about 50 to 150 nm. The recording layer 23 can be formed by a compound containing elements of germanium, antimony (Sb), and tellurium (Te). The upper dielectric layer 24 may be formed zinc sulfide added with silicon oxide, while the reflective layer 25 can be a metal layer, for example, an aluminum layer. A protection layer 26 is then coated on top of the above structure.

FIG. 5 shows a comparisons of the characteristics of the phase transition type optical recording medium (curve I) provided by the invention and the conventional one. The peaks of the curves represent the temperature after being radiated by a laser light. It is shown that the characteristics of both media are similar, therefore, functions such as good transmission and thermal conductivity and capacitance as the conventional recording medium are obtained by the recording medium provided by the invention. That is, the invention provides a phase transition type optical recording medium having a good performance in writing and erasing as the conventional one with a much thinner lower dielectric layer.

For example, considering the time consumed by coating the lower dielectric layer, the coating rate of the lower dielectric layer by RF sputtering is about 10 nm/min, while it is about 50 nm/min for forming the high reflective layer. In the conventional structure, the coating time of the lower dielectric layer is about 15 minutes, while the invention only takes about 4.5 minutes. Therefore, the invention shortens the fabrication time consumption and reduces the fabrication cost effectively without affect the characteristics of writing and erasing.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A phase transition type optical recording medium structure, comprising:
a lower dielectric layer on a substrate;
an adding high reflective layer having a reflectivity much higher than the lower dielectric layer, on the lower dielectric layer;
a recording layer on the high reflective layer; and
an upper dielectric layer on the recording layer.

2. The recording medium structure according to claim 1, wherein the phase transition type optical recording medium further comprises a protection layer on the upper dielectric layer.

3. The recording medium structure according to claim 1, wherein the adding high reflective layer has a thickness of about 15 to 60 nm.

4. The recording medium structure according to claim 1, wherein the adding high reflective layer is formed from at least one of the materials of the IVA group elements in the periodic table.

5. The recording medium structure according to claim 1, wherein the adding high reflective layer is formed from one of the materials of nitride, oxide, sulfide, carbide, and a mixture thereof.

6. The recording medium structure according to claim 1, wherein the lower dielectric layer has a thickness of about 20 nm to 80 nm.

7. The recording medium structure according to claim 1, wherein the lower dielectric layer is formed by zinc sulfide added with silicon oxide or silicon dioxide.

8. The recording medium structure according to claim 1, wherein the phase transition type optical recording medium further comprises a reflective layer on the upper dielectric layer.

9. The recording medium structure according to claim 1, wherein the substrate includes a polycarbonate substrate.

10. A method of forming a phase transition type optical recording medium structure, comprising:
forming a lower dielectric layer on a substrate;
forming an adding dielectric layer having a much higher reflectivity on the lower dielectric layer;
forming a recording layer on the high reflective layer; and
forming an upper dielectric layer on the recording layer.

11. The method according to claim 10, further comprising the step of forming a reflective layer on the upper dielectric layer.

12. The method according to claim 11, wherein the reflective layer has a thickness of about 50 nm to 150 nm.

13. The method according to claim 10, further comprising the step of forming a protection layer on the upper dielectric layer.

14. The method according to claim 10, wherein the adding high reflective dielectric layer has an optimum thickness of about 25 nm.

15. The method according to claim 10, wherein the adding high reflective dielectric layer is formed from at least one of the materials of the fourth group elements.

16. The method according to claim 10, wherein the adding high reflective dielectric layer is formed from one of the materials of nitride, oxide, sulfide, carbide, and a mixture thereof.

17. The method according to claim 10, wherein The recording medium according to claim 1, wherein the lower dielectric layer has a thickness of about 20 nm to 80 nm.

18. The method according to claim 10, wherein the lower dielectric layer is formed by zinc sulfide added with silicon oxide or dioxide.

19. The method according to claim 10, wherein the recording layer has a thickness of about 20 nm to 30 nm.

20. The method according to claim 10, wherein the upper dielectric layer has a thickness of about 20 nm to 70 nm.
